(19) United States
(12) Patent Application Publication
(10) Pub. No.: US 2011/0313871 A1
(43) Pub. Date: Dec. 22, 2011

(54) APPARATUS, SYSTEM, AND METHOD FOR FACILITATING A PAYMENT

(76) Inventor: Laura Greenwood, Lomita, CA (US)

(21) Appl. No.: 13/110,761

(22) Filed: May 18, 2011

Related U.S. Application Data
(60) Provisional application No. 61/345,916, filed on May 18, 2010.

(51) Int. Cl. G06Q 20/00; G06Q 40/00

(52) U.S. Cl. 705/16; 705/39

(57) ABSTRACT

An apparatus, system, and method are disclosed for facilitating customer payment. The apparatus includes a display module, a selection module, and a payment module. The display module displays on a display screen check details corresponding to one or more items ordered by a party made up of one or more members, the one or more items displayed on a display screen. The selection module allows a member to select check details corresponding to being items for which the member wishes to at least partially pay. The payment module allows the member to enter payment details corresponding to a payment method.

### CROSS-REFERENCES TO RELATED APPLICATIONS

This application claims priority to U.S. Provisional Application No. 61/345,916 entitled “Apparatus, System, and Method for Facilitating a Payment” and filed on May 18, 2010 for Laura Greenwood, which is incorporated herein by reference for all that it contains.

### BACKGROUND

1. Field of the Invention

This invention relates to payment devices, systems and methods.

2. Description of the Related Art

Often an item or service, or a group of items and/or services, is purchased by a party having one or more members who wish to split the total cost. This can create difficulties for both the purchasing party members as well as the seller. Purchasers must often work within the bounds of purchasing methods provided by a seller, which often provide no easy way to split the total cost of purchasing one or more items. If sellers do the splitting, on the other hand, they must keep track of the portion that each member wishes to pay for, which can vary greatly from situation to situation, causing confusion and frustration for the buying party and the seller.

More specifically, in the restaurant and bar industries, the process of handling payments is very time consuming both for a guest and for a server. The server time is costly to an establishment as it takes away from the establishment being able to provide service to other customers coming in or waiting for orders. By the time a party is paying for its food, a server should really be expending effort on the new customers coming into the establishment. Additionally, the extra time is also inconvenient for the guest. The guest may have received all the service and food or beverages that the guest desired, and in an excellent manner, but is often inconvenienced in that he or she must remain for while longer to pay. In a busy establishment, this may involve getting the attention of a server to begin or finish payment.

In addition, with establishments that keep a tab, such as a bar, tracking of the tab and facilitating payment can be a hassle. Every item ordered must be logged on the correct persons tab. When a server or bartender is taking multiple orders, walking around an establishment, or performing other tasks it can be difficult to correctly do this. Additionally, this can lead to disputes with customers about whether or not any error was made. Additionally, when a dispute arises it may be hard to convince a customer that the establishment has correctly logged the items on the tab.

In addition, payment in restaurant and other establishments often requires the providing of a credit card, debit card, or other payment card to a server. Because point of sales (POS) terminals are often located out of sight of a parties table, the handling of other peoples' credit card, debit card and creation of separate checks can create worries or problems with payment card security. This is especially true with the rampant identity and payment card theft that occurs today. In fact, some unscrupulous employees have saved payment details for later personal use. That the diners hand over their credit/debit cards to a complete stranger in the hopes that their card information is safe requires that a restaurant or establishment spend extra time, effort, and money ensuring that a patron's information is safe.

Another problem with providing a payment card in such establishments is the requirement for processing and reprocessing the card. Often, a customer provides a payment card which is then taken by a server and processed at a POS terminal. The server then returns the card and a receipt to the customer who then must sign a receipt and specify a tip amount. Then, the server must re-process the card information for the tip amount. This double processing of card information creates extra work and hassle for servers and extra cost for an establishment.

An additional, and common, time consuming process involves the separating of a party's orders into separate checks. This is due to the fact that a party often has more than one paying member. It can be confusing for both server and the party to sort out the cost of the items ordered by different paying groups of the party. Each paying member is also likely to have their own card which must be processed as described above. This whole process can be mistake prone which results in even more trips to the POS terminal to sort it out. This incurs even more additional cost to the restaurant. From a customer's perspective, the service can be absolutely perfect but if the payment process at the end of a meal is times consuming or a hassle, this can dampen the whole experience.

### BRIEF SUMMARY

From the foregoing discussion, it should be apparent that a need exists for an apparatus, system, and method that allow customers to make payments without risking theft of sensitive information. Beneficially, such an apparatus, system, and method would allow members to split the cost of items ordered as a party quickly and easily.

The present invention has been developed in response to the present state of the art, and in particular, in response to the problems and needs in the art that have not yet been fully solved by currently available apparatus, systems, and methods of payment. Accordingly, the present invention has been developed to provide an apparatus, system, and method for facilitating a payment that overcome many or all of the above-discussed shortcomings in the art.

The apparatus to facilitate customer payment is provided with a plurality of modules configured to functionally execute the necessary steps of performing payment. These modules in the described embodiments include a display module, a selection module, and a payment module. The display module displays check details corresponding to items ordered by a party of one or more individuals on a display screen. The selection module allows a member of the party to select one or more check details corresponding to one or more of the items, the corresponding items being items for which the member wishes to at least partially pay. The payment allows the member to enter payment details corresponding to a payment method.

The apparatus, in one embodiment, is configured to perform a split operation, the split operation including selecting a portion of a price less than a full price of the one or more selected items.

A method of the present invention is also presented for facilitating customer payment. The method in the disclosed embodiments substantially includes the steps necessary to carry out the functions presented above with respect to the operation of the described apparatus and system. In one embodiment, the method includes displaying check details corresponding to items ordered by a party on a display screen, the party comprising one or more members. In one embodiment, the method also includes allowing a member of the party to select one or more check details corresponding to the one or more items, the corresponding one or more items being items for which the member wishes to at least partially pay. In one embodiment, the method also includes allowing the member to enter payment details corresponding to a payment method.

The method also may include allowing the displaying check details, the allowing the member to select check details, and the allowing the member to enter payment details to be performed repeatedly until the check has been completely paid.

In a further embodiment, the method includes displaying a graphical user interface on the display screen, the graphical user interface having a number of features displayed at substantially the same time. The number of features include, in one embodiment, a list of the one or more items, one or more split options, one or more payment options, and one or more values indicating the payment status.

A system of the present invention is also presented to facilitate customer payment. The system, in one embodiment, includes a POS terminal, a check details database, and computer readable medium that includes the above modules.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of a payment system in accordance with the present invention;

FIG. 2 is a schematic block diagram illustrating one embodiment of a payment apparatus in accordance with the present invention;

FIG. 3 is an alternate schematic block diagram illustrating one embodiment of a payment apparatus in accordance with the present invention;

FIG. 4 is a perspective view of a payment apparatus according to one exemplary embodiment;

FIG. 5A is an additional schematic block diagram illustrating one embodiment of a payment apparatus in accordance with the present invention;

FIG. 5B is a schematic block diagram illustrating one embodiment of a communication module in accordance with the present invention;

FIG. 6 is a schematic flow chart diagram illustrating one embodiment of a payment method in accordance with the present invention;

FIG. 7 is a schematic flow chart diagram illustrating one embodiment of a method for creating a tab in accordance with the present invention;

FIG. 8 is a schematic flow chart diagram illustrating one embodiment of a method for accessing a tab in accordance with the present invention; and

FIG. 9 is an exemplary screen shot of a user interface allowing a party to split a check between multiple paying party members.

### DETAILED DESCRIPTION

The apparatus, system, and methods disclosed herein have been designed to address the issues discussed above and allow a buying party to quickly and easily process payment for items and services as well as allow the seller to easily track items ordered by a party, or a member of a party. In a restaurant or bar environment, may also allow a server to begin assisting new guests more quickly as very little interaction may be necessary during the payment and/or ordering processes. In fact, the server may only need to interact with a party to address questions about items listed on the check and/or errors on the check.

According to one embodiment of the present invention, a portable electronic apparatus runs customized software that may process and split a restaurant meal bill and/or allow tracking of a tab. According to another embodiment, this customized software runs on any computer or electronic device. According to one embodiment, the customized software runs as a web service in connection with paying for items online, such as items in an online shopping cart. This apparatus and/or software may enable the guest to calculate their portion of the bill, their part of tax and tip and process their own credit card; or they may identify that they will be paying cash, at which time they may receive a receipt for their cash paid part of the check. The apparatus may allow a customer to pay with a payment card from anywhere within the restaurant or bar, including at a table. The customer may thereby retain custody of private information, limiting possibility or likelihood of theft of this information.

According to one embodiment, after a member of a party performs a payment transaction a device calculates the remaining amount due. The device may then be passed to the next person at the table. Once the entire check has been paid in full, a light switches from red to green showing the amount is now paid.

According to another embodiment, the small hand-held apparatus tracks and keeps record of a tab corresponding to a customer. The apparatus may provide tools to ensure that the tab is properly kept and that orders are placed on the correct tab. The apparatus may also provide features that may enable payment to be performed from anywhere within a bar.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

As used herein the term “check” may be used to refer to a bill for an individual or party. The term “personal check” may be used in relation to personal checks written by parties in payment for a bill or a check. The particular meaning of the term within this disclosure should be apparent from its context.

As used herein the term “check details” refers to items ordered in a restaurant, bar, store or other environment. The check details may include information used to identify a check with a party or individual, information describing ordered items, and the like.

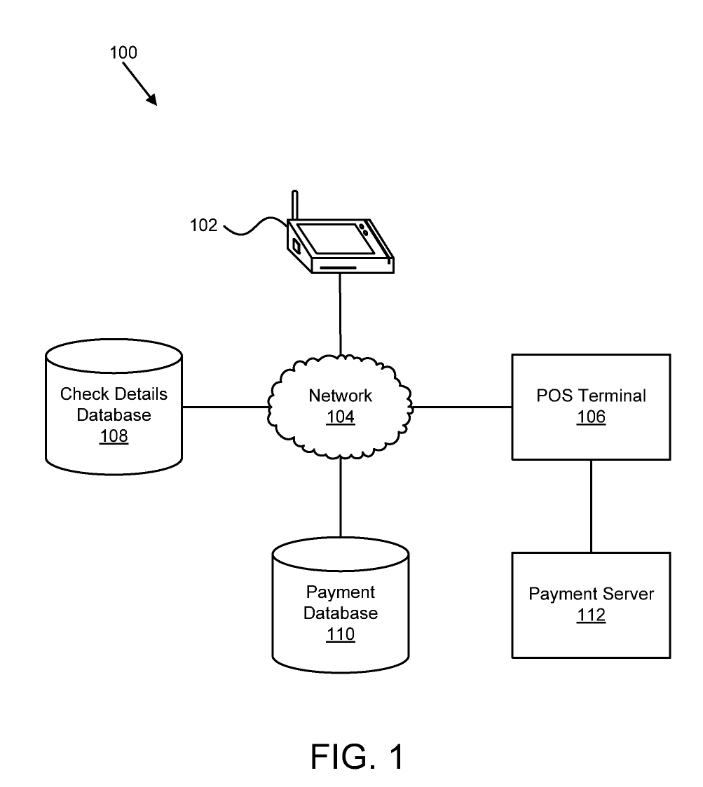

FIG. 1 is a schematic diagram of a payment system 100 according to one embodiment of the invention disclosed herein. The payment system 100 includes a payment apparatus 102, a network 104, a point of sale (POS) terminal 106, a check details database 108, a payment database 110, and a payment server 112. Although the present invention may be used in numerous purchasing environments, the figures and embodiments discussed herein will be primarily directed to restaurant and bar establishments for simplicity of discussion. One of skill in the art, in light of the present disclosure, will understand that the principles, methods, and apparatuses described herein may be used in manners and environments not specifically discussed without departing from the scope of the present invention.

The payment apparatus 102 communicates with a variety of electronic devices and databases over a network 104 to perform an efficient and easy payment transaction. According to one embodiment, check details for a particular party are downloaded from a check details database 108 to the payment apparatus 102. The payment apparatus 102 then displays the check details. According to one embodiment, the payment apparatus 102 may then be brought to the party where one or more members of the party can, in turn, select the items for which they wish to pay and process payment. Individuals may be able to select items from a list displayed on the payment apparatus 102. Payment for the item(s) may be processed by entering payment details into the payment apparatus 102 which communicates the details wirelessly over a network 104 to a POS terminal which may perform a payment transaction with a payment server 112. The payment server 112 may be a credit server or other payment server known within the art. At least partial details of the payment transaction may then be stored in the payment database 110 for records.

The payment apparatus 102 and the associated payment system 100 may allow parties to pay for food or services from any place within an establishment. Additionally, an individual may keep a payment card in sight throughout the payment process without fear of the private card information being logged or stolen. Furthermore, because individuals are able to select the items for which they pay, it is simple to split up the costs of a meal for parties having more than one paying member.

The payment apparatus 102 may also facilitate the management and accessing of a tab. According to one embodiment, the payment apparatus 102 may be used to create a tab. Because of its portable nature, a server may use it from anywhere within an establishment to access the tab corresponding to the correct person. This may allow the establishment and customers to be assured that the items on a tab are properly logged. Additionally, payment may be made from anywhere within an establishment to facilitate ease and quickness of payment.

The payment apparatus 102 is depicted as depicted a portable custom electronic device. However, according to other embodiments, the payment apparatus 102 may be a variety of electronic devices known in the art including a personal computer (PC), a personal digital assistant (PDA), or any other type of portable or non-portable computer or electronic device that contains some combination of one or more of the features, modules, or functions described herein. According to another embodiment, one or more of the features, modules, or functions are provided as a web service which may be accessed over a network. For example, the service may be accessed through web browsing software over the internet.

The POS terminal 106 may be a terminal on which a payment transaction occurs. The POS terminal 106 may be a terminal through which a payment transaction may be initiated. The POS terminal 106 may include any collection of hardware and/or software which performs and/or initiates a payment transaction. POS terminals 106 well known in the art may perform one or more of cash transactions, personal check transactions, e-check transactions, payment card transactions, gift card transactions, and the like. The POS terminal 106 is shown in communication with a payment server 112 which may process e-check transactions, payment card transactions, and other electronic payment transactions available in the art that are transacted by the POS terminal 106. Virtually all food and bar establishments, as well as almost any store that sells goods, has a POS terminal 106 on which payment for goods, services, or food occurs. Thus, many establishments already have a POS terminal 106 with which the payment apparatus 102 can communicate to perform the convenient payments as described herein. Exemplary POS terminal's known in the art include cash registers, processing devices, payment software, and the like.

According to one embodiment, they payment system 100 includes a check details database 108. The check details database 108 may be a database that includes information about items ordered by parties at the restaurant. The check details may include not only information about the items purchased, such as a name, description, and price, but also include an identifier used to link the check details to a party. The identifier may be a table number, table description, name, tab identifier, or any other identifier that connects the check details to a specific party or member of a party in the establishment. According to one embodiment, the check details database 108 may also include information about one or more tabs.

The check details in the check details database 108 may be placed therein by entering orders for food, beverages, or other goods or services, into a variety of devices in a variety of manners. According to varying embodiments, orders are entered into the payment apparatus 102, POS terminal 106, or any other device in electronic communication with the network 104 and/or check details database 108. When an order for an item is placed, corresponding check details may be entered or created in the check details database 108. According to other embodiments, orders may be entered into the payment apparatus 102.

According to one embodiment, the payment system 100 may include a payment database 110. The payment database 110 may contain information about payment transactions performed or attempted on the POS terminal 106 or other electronic devices on the network 104. For example, according to one embodiment, when a member of a party submits payment card details on the payment apparatus 102 in payment for food, the payment apparatus 102 communicates the payment details to the POS terminal 106, which then performs the transaction with the payment server 112. Upon completion of the transaction, rejection of the transaction, or error, the POS terminal 106 may send transaction details to the payment apparatus 102 to notify the member and/or to the payment database 110 for logging and recording of the transaction or error.

The check details database 108 and the payment database 110 may be databases located on one or more computers, processing devices, storage devices, or servers that are in communication with the network 104. According to one embodiment, a computer operates as both a POS terminal 106 and a host for the check details database 108 and the payment database 110. According to another embodiment, the databases 108, 110 are located on a different computers or memory devices than the POS terminal 106. According to yet another embodiment, one or both of the databases 108, 110 may be distributed across multiple memory devices or computers. According to one embodiment, the databases 108, 110, or a portion of one or both of them, may be stored on the payment apparatus 102.

According to one embodiment, check details may be placed in the check details database 108 when an order is placed by a customer. For example, an order may be received by a server, waiter, or waitress and then entered into a device in communication with the network 104. The device may then send the order information to the check details database 108. According to one embodiment, an order may be entered into the payment apparatus 102 and communicated to the check details database 108. The details of the order may be saved in the check details database 108 for access by devices such as the POS terminal 106 and/or the payment apparatus 102.

According to the depicted payment system 100 a network 104 is used for communication between the payment apparatus 102 and other devices or elements connected to the network 104. The network 104, according to one embodiment, has both wireless and wired communication capabilities. For example, the network 104 may communicate wirelessly with the payment apparatus 102 but across a wired connection with the POS terminal 106. The network 104 may include one or more wireless and/or wired routers for communication between devices, including communication between the POS terminal 106 and the payment server 112.

Although the depicted embodiment includes a network 104 through which the payment apparatus 102 communicates with other devices, other embodiments have communication ability directly between devices. For example, the payment apparatus 102 may communicate directly with the POS terminal 106, or another device, in a wireless or wired manner. According to one embodiment, the one, more, or all of the check details database 108, the payment database 110, the payment apparatus 102, and the POS terminal 106 are included on a single device. In one embodiment a network 104 may not be needed.

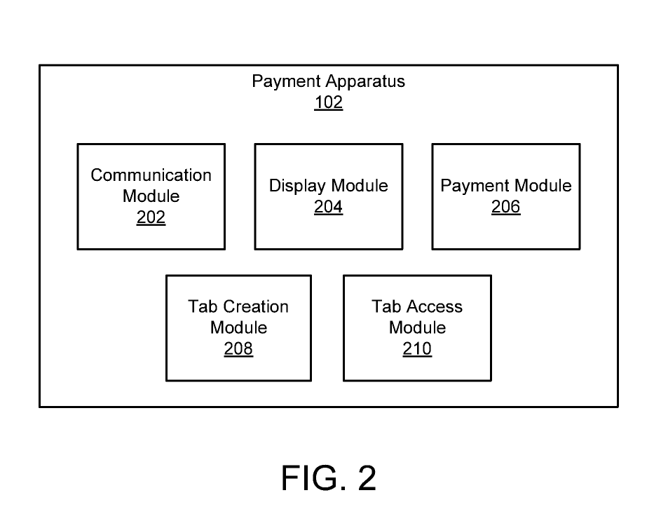

FIG. 2 is a schematic diagram of one embodiment of a payment apparatus 102 for facilitating payment. The depicted embodiment of the payment apparatus 102 of FIG. 2 includes tab tracking features which may be useful in some establishments, such as establishments that include a bar or bar type services. The payment apparatus 102 operates to facilitate ease of tracking of orders and payment for food, services, or drinks from anywhere in an establishment. The payment apparatus 102 has a communication module 202, a display module 204, a payment module 206, a tab creation module 208, and a tab access module 210.

The communication module 202 may enable communication with electronic devices separate from the payment apparatus 102. For example, in the depicted payment system 100 of FIG. 1, the communication module 202 may enable communication between the payment apparatus 102, the network 104, and/or devices connected to the network 104, such as the POS terminal 106. The communication module 202 may be enabled to communicate in a variety of manners. According to various embodiments, the communication module 202 may communicate in wired or wireless manners. These may include one or more of communication over a USB port, a serial port, a network cable, an antenna for wireless or blue tooth communication or any other wireless or wired communication known in the art. The communication module 202 may include hardware and/or software to perform the wireless and/or wired communication.

The tab creation module 208 may perform operations to create a new tab for a customer. The tab may be used to track the purchases of a customer so that the customer need only perform one payment transaction for all of the items purchase. For example, a customer may order a number of drinks during an evening while a tab corresponding to the customer may be updated with the additional orders. At the end of the evening, before leaving, the customer may then perform a single payment transaction to pay for all of the orders. This is similar to tabs kept in many bars or other establishments.

According to one embodiment, the tab creation module 208 may guide a bartender/server in the creation of a new tab for a new customer. The tab creation module 208 receives customer information on which to base the new tab. The customer information may include one or more of a variety of information including a name, payment card details, a driver license number, a picture, a fingerprint, or any other customer information that the establishment wishes to gather. For example, a bar may be worried about people not paying for drinks before leaving. Gathering payment information up-front may ensure that payment is received. Additionally, other details may serve to ensure that the tab is connected to the correct individual. For example, a picture of the individual may be received by the tab creation module so that a server can be sure that the person using the tab is the correct person. According to one embodiment, the payment apparatus 102 may have a built in camera to quickly take pictures of new customers.

According to one embodiment, after customer information has been received by the tab creation module 208 the tab creation module 208 may return a tab identifier. The tab identifier may be a number, receipt, or other type of identifier so that the customer can be quickly identified with the proper tab. According to one embodiment, the tab creation module uses a number, a picture, a fingerprint or other information about the customer as a tab identifier. According to one embodiment, a scannable bar code may be printed. According to another embodiment, more than one type of information may be used, such as a number and a picture. Multiple tab identifiers may allow a customer to be identified with the correct tab in a variety of ways.

The creation of a new tab may take place on the payment apparatus 102 or on a separate apparatus. For example, a separate apparatus, such as a separate payment apparatus 102, computer or other electronic device or processing device may be used to create a tab for newly arriving customers. A separate bar employee may work with the new customers to gather and enter their information, or the new customers may use the apparatus on their own and be stepped through the tab creation process by the apparatus. For example, a touch screen device may be provided at an entry where new customers may set up their tabs.

The creation of a tab using a separate apparatus may enable a variety of useful methods of processing payment. For example, according to one exemplary embodiment, the bar can run in a “cashless prepayment” manner such that servers and bartenders do not, or rarely, handle cash. In one embodiment of a cashless method, a new customer comes into the bar and begins using an apparatus to create a new tab. Among various questions answered by the new customer may be the method of payment that the new customer wishes to use. If the new customer is using a credit card, debit card, or gift card the apparatus may request the card information, such as the card number. According to one embodiment, if the new customer is using cash or check, the apparatus may request an amount to be paid up front. The apparatus or a bar employee may then collect the up-front payment. According to another embodiment, the apparatus may allow the entering of multiple payment methods and/or information corresponding to multiple payment cards. According to one embodiment, the payment methods and/or information may correspond to more than one individual.

Following receipt of sufficient customer and/or payment information, a tab may then be created that is associated with the entered information or prepaid cash. The customer may then be provided a tab identifier, receipt, or a card indicating his prepaid status. Later, when the customer places an order the customer may provide the customer's corresponding tab identifier, receipt or card. The order, and any tips, may then be processed against that tab and any prepaid amount. However, because some gift cards may have limits on tip amounts, the bar employees may not be able collect a full tip amount indicated by a customer. According to one embodiment, when the customer is ready to leave any unpaid amount of prepaid cash may be returned to the customer.

The cashless prepayment method described above may provide advantages for both the bar establishment and the bar employees. For example, servers and bartenders need not count or handle cash amounts or worry about keeping tips and cash payment separate. The bar may find that revenue is increased as payment may not be misinterpreted as a tip by bar employees. It may also make it much more difficult for bar employees to purposely divert payments to a tip jar. Additionally, customers may be benefited by having a more streamlined and easy order process. According to one embodiment, establishments may incentivize use of the prepayment method or cards by providing discounts or other promotions. The method describe above also illustrates that a customer tab need not be created by the payment apparatus 102 but may also be created by a variety of other devices running proper software. For example, regardless of the device that creates a tab, the tab information may be stored such that it is accessible the payment apparatus 102. For example, the tab information may be stored in a tab database, the check details database 108, or any other database.

The tab access module 210 may perform operations to allow a server or other employee to access the tab of a particular customer. For example, the tab access module 210 may receive a tab identifier and bring up details about the corresponding tab. According to one embodiment, the tab identifier is a number that was assigned to the tab when it was created. When a customer wishes to place an order with a server the customer may provide the number. The server may then enter the number into the payment apparatus 102 to bring up the correct tab. The tab access module 210, upon receipt of the tab identifier, may then display information relating to the tab such as the customer information. In this manner, the server may be able to double check that the individual providing the tab identifier is really the correct customer. According to one embodiment, the tab access module 210 displays the picture of the customer with whom the tab is associated. The server can quickly and easily confirm that the individual is in fact the correct customer. According to another embodiment, a fingerprint reader reads the customer's finger. According to yet another embodiment, a shape or other symbol or information may be displayed. The server may then be able to ask the customer what shape, symbol, or other information is associated with the tab. If the customer responds correctly, the server may then know that the customer is accessing the correct tab.

When a tab has been brought up, the tab access module 210 allows management of the tab, allowing a server or customer to take various tab management steps. The tab management steps may include steps such as placing an order, adding a new item to the tab, removing an item from the tab, viewing items on the tab, viewing customer information related to the tab, providing an incremental tip, initiating payment for the items on the tab, closing the tab, and deleting the tab. According to one embodiment, an incremental tip is a tip provided to the server after an item has been delivered. According to this embodiment, a customer can provide tips throughout an evening rather than waiting until the customer wishes to pay the entire tab. The incremental tip option, according to one embodiment, allows the customer to provide a tab identifier and then enter a tip amount. This may happen many times throughout a night.

The foregoing list is only exemplary as other management steps may also be provided. A server may enter an item number or other details about an item which the customer has ordered. The item may then be added to the tab. According to one embodiment, an order may be placed from the payment apparatus 102. Thus a server may place orders via the payment apparatus 102 and walk by the bar or kitchen to get the ordered item(s). In this way, the server may not need to travel back and forth between tables to takes orders and a kitchen, bar, or ordering station to place orders but may place orders from anywhere within the establishment and only visit a kitchen, bar, or ordering station to retrieve and deliver ordered items.

The tab access module 210 may also require confirmation steps by the customer. For example, the customer may be required to press a confirmation button to confirm the addition of an item to the tab. The customer may alternatively or additionally be required to swipe a finger on a finger print reader to confirm that the customer did in fact order the item, or confirm some other management step on the tab. This may impress upon the customer that their orders are being accurately tracked and the customer may thus have a difficult time disputing charges later on.

The payment module 206 may perform operations to facilitate customer payment on the payment apparatus 102. The payment module 206 may allow a user to confirm or enter payment details to perform the payment transaction. The payment module 206 may allow paying via card, cash, check, e-check, online payment services such as PayPal®, or a variety of other payment methods known in the art. According to one embodiment, the payment apparatus 102 transmits payment information obtained or confirmed by the payment module 206 to a POS terminal 106 using the communication module. Transmission may be done wirelessly allowing the customer to be at any location within an establishment while not requiring the customer to let a payment card or other sensitive information out of the customer's sight. According to one embodiment, when an outstanding balance of a tab has been paid, the tab may be closed. Closing a tab after the tab has been paid in full may involve the deletion of a tab, or the changing of a value in the tab to indicate that the tab is closed or inactive. According to another embodiment, the details of the items purchased are saved in a separate database which can be used to log customer purchases. According to one embodiment, the tab may not be closed but may be saved for later visits by the customer to the establishment.

The display module 204 may display check details and other elements on a screen for a restaurant or bar worker or customer to view and/or interact with the payment apparatus 102. According to one embodiment, the display module 204 facilitates actions taken by the other modules 202, 206-212. For example, the display module 204 may allow a server to interact with the payment apparatus 102 to instruct it to communicate with other devices using the communication module 202. The display module 204 may also display tab creation options available through the tab creation module 208 or tab management options available through the tab access module 210. The display module 204 may also provide a user interface that allows a user to use the payment apparatus 102 and any included modules.

According to various embodiments, information regarding the tab, such as payment information, check details, customer information, etc., may be stored in various locations. For example, information regarding the tab may be stored in the check details database 108, on the POS terminal 103, and/or on the payment apparatus 102. These various locations may require different operations that may affect the use of the payment apparatus or the methods described herein.

According to one embodiment, tab information and payment information may be primarily stored in a location not on the payment apparatus 102. In such an embodiment, information may be downloaded do the payment apparatus 102 as needed. For example, when a tab is accessed, information is downloaded from a location in the system 100 to the payment apparatus. When access to the tab is no longer needed, changes to the tab may be uploaded to a location on the system 100 and the information may be removed from the payment apparatus 102.

According to another embodiment, the information may be stored primarily on the payment apparatus 102. This may require less communication between the payment apparatus 102 and other devices of the system 100. According to another embodiment, the information is stored on both the payment apparatus and on another device of the system 100. For example, synchronization between a payment apparatus and other device may occur periodically or as needed.

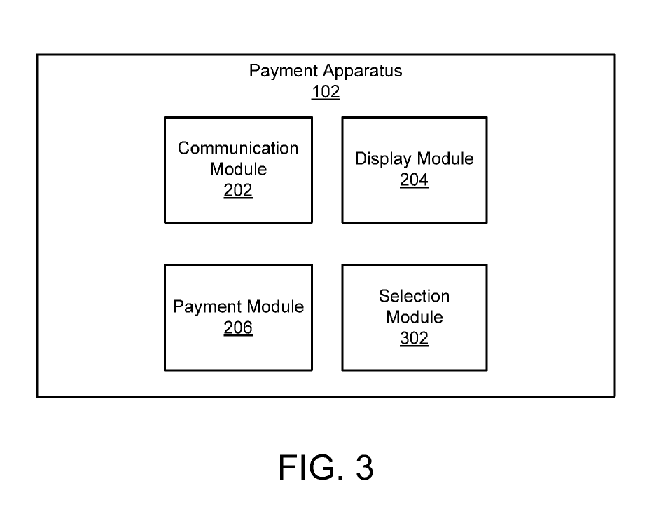

Turning to the next figure, FIG. 3 is a schematic diagram of one embodiment of a payment apparatus 102 for facilitating payment. The depicted embodiment of the payment apparatus 102 of FIG. 3 includes splitting features which may be useful in some establishments. Similar to the payment apparatus 102 of FIG. 2, the payment apparatus 102 of FIG. 3 is depicted as including a communication module 202, a display module 204, and a payment module. However, according to the depicted embodiment, the depicted payment apparatus does not include a tab creation module 208 or tab access module 210 but does includes a selection module 302.

The selection module 302 may perform operations to split the cost of a check or one or more items purchased by a party. The selection module 302 may allow selection of one or more check details corresponding to one or more items ordered by the party. As previously discussed, the display module 204 may display the check details on a display, according to one embodiment. A member of the party may select one or more items by using an input device to interact with the payment apparatus 102. According to one embodiment, the payment apparatus 102 includes an input device such as a touch screen display or a keypad. An individual may be able to input information, for example, into the touch screen display or keypad using a finger or stylus. The selection module 302 may default to having a member pay for the full amount of a selected item. According to one embodiment, the selection module 302 provides an option to “split” the item, which can then be selected by the member.

Splitting may be done for example, if the member wishes to pay some fraction of the price of the item. The selection module 302 may receive this instruction and provide options to the member of the party on how to split the item. These options may include entering a numerical fraction that represents the portion of the item for which the member wishes to pay or entering a dollar-cent amount. For example, the member may enter a numerical fraction such as ½, 1/3 or any other numerical fraction. This may be desirable if the item was split between 2, 3 or more members. Selecting or entering the fraction may be done, for example, using a physical keypad, or an onscreen keypad on a touch screen display on the payment apparatus 102. Alternatively, the member may select an option to enter a dollar-cent amount. For example, the member may wish to pay $3.25 of a $7.00 item which the member shared with another member of the party. The member may enter this using an input device.

According to one embodiment, multiple items may be selected and/or split at the same time. According to one embodiment, the selection module 302 offers an option to split all items remaining on the check. This may be useful, for example, when the members of a party wish to split the full cost of a meal.

The selection module 302 may also provide other options in how to split an item. For example, there may be a table guest option that splits the cost of selected items among all paying members of a party. This may be offered for the convenience of paying for a member of the party who is being honored. For example, the party may be celebrating a birthday, graduation, or any number of other accomplishments or events relating to one of the party members. According to one embodiment, the first member of a party to use the payment apparatus 102 to pay, may first select the items ordered for an honored member, then select a table guest option to split the cost of these items, and also enter a number corresponding to the number of paying party members. For example, the first paying member may enter that there are 5 paying members and would thus pay for ⅕^{th} of the honored member's ordered items. When the next member of the party goes to make payment using the payment apparatus 102, the selection module 302 defaults to assigning him or her ⅕^{th} of the items selected and so designated by the first paying member. According to one embodiment, a later paying member may be able to select or deselect the items of the honored guest.

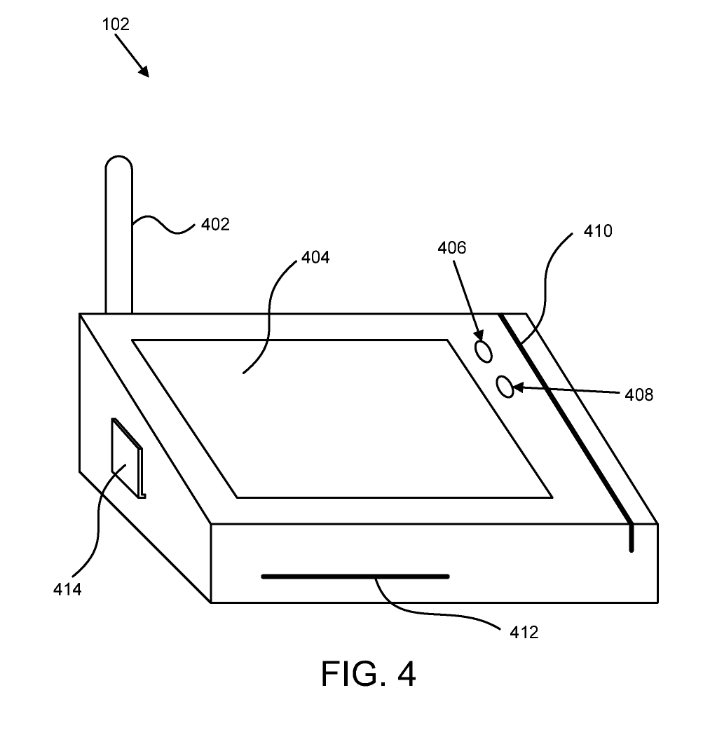

Turning now to FIG. 4, a perspective view of one embodiment of a payment apparatus 102 is shown. The payment apparatus 102, as depicted, includes various features that may be found on one or more exemplary embodiments. These features include an antenna 402, a display screen 404, indicator lights 406, 408, a card slot 410, a printer slot 412, and a clip 414. Other features not shown, but which may be present in various embodiments, include a camera, a barcode scanner, a portable electrical source such as a battery, one or more wired communication ports, and a physical keypad.

The antenna 402 may allow the payment apparatus 102 to communicate wirelessly with other electronic devices or systems, such as a network 104 or one or more POS terminals 106. The size, shape, and placement of the antenna 402 is exemplary only and can vary greatly, as will be understood by one of skill in the art in light of the present disclosure. For example, the antenna 402 is depicted as an external multi directional antenna. However, other embodiments may include internal and/or directional antennas. Additionally, the antenna 402 size, shape, and configuration may vary depending on the type of wireless communication performed. For example, the antenna 104, or an additional or alternate antenna, may be configured for use in Bluetooth, wireless networking, mobile phone, or other wireless communication standards. The antenna 402 may be supplemented or replaced by additional antennas of different types and configurations.

The display screen 404 may allow the payment apparatus 102 to display information for a user to view. For example, check details and other instructions may be displayed on the display screen 404. According to one embodiment, the display module 204 may control the display screen 404 and interact with other modules or devices to display information on the display screen 404. For example, the display module 204 may provide a user interface on the display screen 404 to facilitate use of the payment apparatus 102. Additionally, the display module 204 may interact with other modules, such as the modules shown in FIGS. 2, 3, and 5 to provide options, instructions, and information to a user.

In addition to operating as a display, the display screen may also operate as an input device. For example, according to one exemplary embodiment, the display screen 404 may be a touch screen that allows a user to interact with the payment apparatus 102 by touching the display screen 404 with a finger or a stylus. In such embodiments, the payment apparatus 102, may not require other user input devices or ports. In other embodiments, additional or alternate types of input devices may be available such as mouse ports, a physical keypad, or any other type of input device. For example, even if the display screen 404 is a touch screen, a pen input device may also be included for interaction with the display screen. According to one embodiment, a pen input device may be used by a customer to provide a signature for a payment transaction.

The indicator lights 406, 408 indicate a current status of the payment apparatus 102 or a status of information on the payment apparatus 102. According to one embodiment, the indicator lights include a payment indicator 406 and a data indicator 408. The payment indicator 406 may indicate the payment status of a check and may have a plurality of modes. According to one embodiment, the payment indicator 406 has a payment ready mode indicating that a check is ready for payment. This may indicate that the check details for a certain party have been completely and properly uploaded and that a server can turn the payment apparatus 102 over to the party for payment. The payment indicator 406 may also have a payment complete mode to indicate that all items on the check have been properly processed and/or paid for. Other modes are also possible and may be of interest. For example, the payment indicator 406 may have an additional mode for indicating that the payment apparatus 102 is currently performing a payment card transaction.

The data indicator 408 may indicate the status of data currently residing on the payment apparatus 102. According to one embodiment, the data indicator 408 may indicate that there is data on the payment apparatus that needs to be communicated to another device on the network. This may be because there is a network or software error, or there are other limitations on how data is communicated. For example, according to one embodiment, certain types of data may only be communicated in a wired manner. According to another embodiment, communication of certain data may require entry of a password or pass code. The data indicator 208 may indicate that certain steps need to be performed by a server or employee such as entering a pass code, plugging the payment apparatus 102 in for wired communication, etc.

The data indicator 408 may have a plurality of other modes as well. According to one embodiment, the data indicator 208 may have a data ready mode to indicate that data has been correctly downloaded to the payment apparatus 102. According to one embodiment, the data indicator 208 may have a communication error mode to indicate that there was an error in communication. The data indicator 208 may have a wired communication mode to indicate that the payment apparatus 102 needs to be plugged in for wired communication. A variety of other modes may also be useful as well.

The different modes of the indicator lights 406, 408 may be shown by the indicator lights 406, 408 in a variety of manners. For example, the indicator lights 406, 408 may change color and/or change blinking frequency or length to indicate a specific mode. Additionally, the number of indicator lights 406, 408 may vary. For example, fewer or more indicator lights 406, 408 may be used to indicate the status of the payment apparatus 102. Additional modes or statuses may be indicated by the indicator lights 406, 408 or additional indicator lights. Statuses of the payment apparatus 102 that can be indicated by the indicator lights 406, 408 include but are not limited to the status of data, communication, payment, hardware concerns such as battery or ink level, or numerous other statuses.

The indicator lights 406, 408 may be any of a variety of light emitting devices. These include well known light emitting devices such as light emitting diodes (LED's) or other light emitting lamps as well as lesser known light emitting devices, newly developed light emitting devices, or not yet developed or invented light emitting devices. According to one embodiment, messages or indicators displayed on the screen 404 may serve the same or a similar purpose to display lights 406, 408.

The card slot 410 may allow swiping of magnetic cards such as payment cards, identification cards or other cards well known in the art. The card slot may allow for easy entry of payment data for payment cards to speed up the payment process. The card slot 410 may also be used by employees or servers to perform operations that an establishment does not want to allow to be performed by customers. For example, cards may be issued to employees of a restaurant or bar establishment for use with the payment apparatus 102. Although the card slot 410 is specified for use with magnetic cards other features may also be included on the payment apparatus 102, such as features that read other types of cards, such as radio frequency identification (RFID) cards or features that read checks, such as the MICR lines on a check. The type of card may not be important but the ease of entry of details and interaction with the payment device 102 may be important. Thus, variations on the types of cards or methods of entering data may vary greatly.

Through the printer slot 412 receipts or other printed items may be dispensed. According to one embodiment, a tab identifier may be printed and dispensed through the slot 412 to be provided to a customer or party. According to a supplementary or additional embodiment, a receipt is printed to provide proof of payment or to allow an individual to provide a signature.

The clip 414 may allow cash, personal checks or receipts or other items to be conveniently held by the payment apparatus 102. For example, if a member of a party pays with cash, the member may enter details of payment into the payment apparatus 102 and slide an amount of cash into the clip 414. A similar procedure may take place for payment via personal check. Additionally, a server, when clearing a table may gather up the payment apparatus 102 and place any receipts, such as signed receipts, cash or other paper items into the clip for ease in carrying. According to one embodiment, the clip 414 is replaced or supplemented by a coin holder for holding coin currency.

As previously mentioned, features other than those shown in FIG. 4 may also be included. A camera (not shown) may be included for picture taking. A camera may be useful in identification of customers, such as to ensure that they are associated with the correct tab, particularly in settings where customers may roam around an establishment, such as in a bar or club. Additionally, a physical keypad may also be included. Furthermore, because the payment apparatus 102 is portable a battery or other portable electrical source internal to the apparatus may also be desirable. Ports for wired communications (not shown) such as a USB port, network port, serial port, or a variety of other ports for communicating with other devices over a wired connection may also be included.

As will be understood in light of the present disclosure by one skilled in the art, the payment apparatus 102 and its shape and features, as depicted in FIG. 4, are exemplary only. Significant variation of the shape size, and materials is possible without departing from the scope of the disclosed invention. Additionally, numerous attributes of the payment apparatus 102 may be changed, modified or added without changing the nature of the apparatus. For example, the apparatus may be designed to be waterproof and/or washable such as if the apparatus is used in a food and/or beverage environment.

According to one embodiment, the payment apparatus 102 is portable and may be moved throughout an establishment. According to another embodiment, the payment apparatus 102 may be tethered to a specific location within an establishment. In various embodiments, the payment apparatus 102 may have one or more cradles (not shown) where the payment apparatus 102 may be tethered or docked. A cradle may provide a location where the payment apparatus 102 may be mounted so that it will not be dropped or removed. According to one embodiment, the payment apparatus 102 may be locked in place in the cradle so that only an authorized user may remove the payment apparatus 102. According to another embodiment, the payment apparatus 102 may be portable between one or more cradles.

A cradle may also include other features such as an electrical power port or a communication port, similar to cradles or docks used with laptop computers or other devices. For example, placing the payment apparatus 102 within a cradle may create contact between an electrical power port on the cradle and an electrical power port (not shown) on the payment apparatus 102. In one embodiment, the payment apparatus 102 may be powered in this manner. In one embodiment, a battery of the payment apparatus 102 may be charged in this manner. Placing the payment apparatus 102 within a cradle may also create contact between a communication port on the cradle and a communication port on the payment apparatus 102. This may allow for wired communication between the payment apparatus 102 and a network or other device, such as the network 104.

Although the payment apparatus 102 is depicted in FIG. 4 as a custom device for processing payment, the principles and methods disclosed herein can be executable on numerous general purpose processing devices such as computers, cell phones, PDAs, tablet computers, pad computers, or any other processing devices. For example, software, accessories, or modules may be installed or attached to an existing processing device to enable the functionality discussed herein.

According to one embodiment, a payment apparatus comprises software installed on a mobile phone. For example, an application, such as an app from an app store may, be installed on an Apple®, Android®, Windows®, or any other mobile phone to create a device that includes one or more of the modules of FIGS. 2, 3, 5 or any of the figures discussed herein. Accessories such as a card swipe accessory or other accessories may be added to a mobile phone to provide additional functionality or ease of use. Many mobile phones include cameras which may be used for taking pictures or providing additional functionality as needed.

According to another embodiment, a phone may be used to access a website where payment for food, goods, or services may be performed. For example, software comprising any of the modules or functionality discussed herein may be accessible over the internet. In this embodiment it may not be necessary to install software on a cell phone, computer, or any other processing device as it can simply be accessed over the internet.

According to one embodiment, a mobile phone or other processing device with software installed, or with access to a payment website, may be used by a server or other establishment employee to process a party's payments.

According to another embodiment, a mobile phone of a member of a party may be used to process one or more payments for the party. For example, a member of a party may download and install an app from an app store and thereby incorporate the functionality of a payment apparatus 102 into a phone. The member of the party may then be able to process one or more payments of the party using the mobile phone. The establishment may receive a message, such as an email or other type of message, as confirmation that the party has completed payment. According to one embodiment, a party at an establishment may access a website that provides the functionality discussed herein to process payment for goods or services at an establishment.

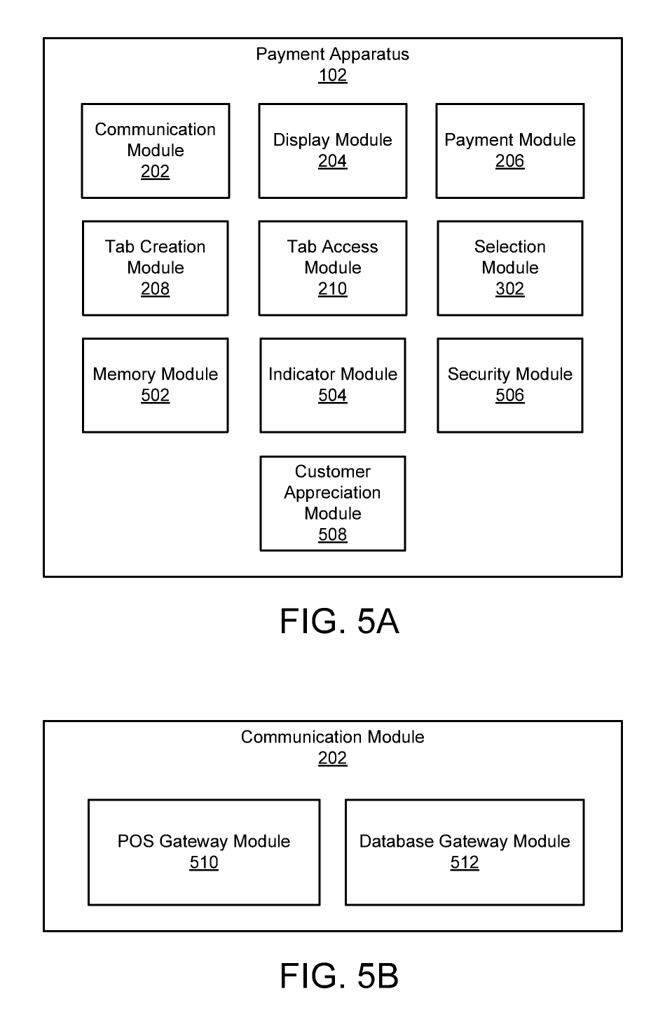

Turning to FIG. 5A, a schematic diagram of one embodiment of a payment apparatus 102 for facilitating payment is shown. The payment apparatus 102 includes modules 202-210 and 302 from FIGS. 2 and 3 as well as additional modules. The additional modules depicted include a memory module 502, an indicator module 504, a security module 506, and a customer appreciation module 508. These modules 502-508 may provide functionality that may be desired or needed in some embodiments.

The memory module 502 may store and manages information stored on the payment apparatus 102. According to one embodiment, the memory module 502 may manage memory in which information may be stored. According to one embodiment, the memory module 502 may include memory for storage of data. For example, data regarding the check details of a tab or a party check may be loaded into memory managed by the memory module 502. Additionally or alternately, data entered into the payment apparatus 102 may be stored in memory managed by the memory module 502. Portions or all of the data managed or stored by the memory module 502 may be made available for the operations of modules 202-210, 302, and 502-508. For example, the data managed or stored in the memory module 502 may include data for a user interface, such as a graphical user interface (GUI), instructions for one or more of the modules or data entered into the payment apparatus 102, or other types of data.

The indicator module 504 may control or provide operations or functions for the indicator lights 406, 408 of FIG. 4 or additional or alternate indicator lights or indictor or messaging functions. The indicator module 504 may include circuitry driving the lighting, blinking, and/or color change of indicator lights 406, 408. The indicator module 504 may poll other modules and/or receive information and/or instructions from one or more of the other modules 202-210, 302, and 502-506 to determine the status of the operation of any aspect of the payment apparatus 102. The indicator module 504 may drive a mode of one or more of the indicator lights 406, 408 to reflect the status of an aspect of the payment apparatus 102 based on information received from other modules.

The security module 506 may offer security operations, functions, or features needed or desired for the payment apparatus 102. According to one embodiment, the payment apparatus 102 is left unsupervised with a customer or party. The security module 506 may provide security of the payment apparatus 102 as well as data residing on the payment apparatus 102. According to one embodiment, the security module 506 includes an alarm feature to signal that the payment apparatus 102 is being tampered with or has been moved to an unauthorized location, such as a location outside a restaurant or bar establishment or near an entrance of a restaurant, bar, or other establishment or venue. According to another embodiment, the security module 506 may include a data encryption feature which encrypts data residing on the payment apparatus 102 or data transmitted to or from the payment apparatus 102, such as data communicated using the communication module 202. According to one embodiment, the data set up may be protected by Department of Defense (DOD) level type of security to prevent unauthorized to access the important data required to post money or perform payment transactions using the POS terminal or a gateway payment provider.

According to one embodiment, the security module 506 restricts the amount or type of information residing on the payment apparatus 102 at a given time. For example, the security module 506 may allow only information regarding one individual or party to reside on the payment apparatus 102 at a single time. In one embodiment, the security module 506 allows only data corresponding to one tab to reside on the payment apparatus at a single time. According to an alternate or additional embodiment, the security module 506 allows payment details for only a single individual to reside on the payment apparatus at a single time. According to an alternate or additional embodiment, the security module 506 allows check details for only a single party, such as a number of customers seated at a single table, to reside on the payment apparatus at a single time. According to one embodiment, data regarding a single individual, party, or payment transaction is downloaded and uploaded to a network 104, or a device connected to the network.

According to another embodiment, the security module 506 locks the payment apparatus 102 in a variety of modes. These modes may include a customer mode for when the payment apparatus 102 will be in the hands of a customer or party. This mode may, for example, restrict the usage of the payment apparatus 102 to selection of and payment for check details residing on the payment apparatus 102 at that time. A pass code or other method of unlocking the payment apparatus 102 may be needed to get the payment apparatus 102 out of this mode. For example, an establishment employee may be requires to swipe a card or enter a pass code to unlock the apparatus. Other modes may include a bar mode that provides features, methods, and options useful to a bar environment or a restaurant mode that provides features, methods, and options useful in a restaurant environment. An additional or alternate mode may include a communication mode that allows the selection and download of information regarding a tab, individual and/or party. Another mode may include a payment mode allowing for the payment apparatus 102 to communicate with a POS terminal for the performing of a transaction.

As will be understood by one skilled in the art and in light of the present disclosure other security features and methods may also be provided by the security module 506.

The customer appreciation module 508 may provide functions, options, or features that may be used to provide rewards for customers and/or incentives to use an establishment's services in a desired manner. According to one embodiment, the customer appreciation module 508 logs and saves the purchases made by the same customer. For example, the customer appreciation module 508 may log the items ordered by the customer in a restaurant or a bar. For example, the purchases may be saved to a database for later access. According to one embodiment, customers can opt to save their favorite items for quick reorder on subsequent visits or purchases.

According to one embodiment, the establishment may provide rewards based on this information. For example, the establishment may provide coupons for reduced price on items. Or, the establishment may wish to incentivize the use of credit cards or its cashless prepayment method. By tracking the amount of money spent using a certain payment method, providing rewards based on this amount, and informing customers of the program, the establishment can influence the way customers use their services.

According to one embodiment, the establishment may base the provided rewards on what the customer generally purchases. For example, the establishment may provide a free coupon for items that the customer usually purchases to provide an award that will be better appreciated. Alternately, the establishment may use the customer's past purchases to predict what other items or services the customer might be interested in and provide coupons for those. According to one embodiment, these coupons or rewards may be provided to a customer by email, phone, text, etc. For example, the customer may provide such contact information through the payment apparatus 102, on a website, or through a variety of other manners.

As will be understood in light of the present disclosure by one of skill in the art, the above incentives and logging of customer purchases is exemplary only. Various other methods are also possible and may be useful. Furthermore, it will also be understood that the combination of modules depicted in the embodiments of FIGS. 2, 3 and 5 are exemplary only. Any combination of modules 202-210, 302, and 502-508 without limitation, may be found in various exemplary embodiments.

With regard to FIG. 5B, a schematic block diagram of an exemplary communication module 202 is shown. The communication module includes a POS gateway module 510 and a database gateway module 512. The POS gateway module 510 may enable the communication module 202 to communicate with a POS terminal 106 and any specialized software running thereon. For example, POS terminals 106 often run specialized or proprietary software for processing payment transactions, such as orders and/or check bills, and may process or communicate information in a different manner than the payment apparatus 102. The POS gateway module 510 may act as a portal between different protocols or methods of handling information between the two devices. In other words, the POS gateway module 510 may take data that is in a form that can be understood by the payment apparatus 102 and convert it into a form that can be understood by the POS terminal 106. In order to create the POS gateway module 510 it may be necessary to obtain information from the creator of the software running on the POS terminal 106. According to one embodiment, a plurality of POS gateway modules 510 is available for communication with varying types of POS software.

The database gateway module 512 enables the communication module 202 to communicate with one or more databases, such as the check details database 108 and/or the payment database 110 of FIG. 1. Similar to the POS gateway module 510 and the POS terminal 106, the database gateway module 512 may be needed for the communication module 110 to act as a portal between different protocols or methods of handling data on the payment apparatus 102 and in a relevant database.

As will be understood by one of skill in the art in light of the present disclosure, the modules provided in FIG. 5B are exemplary only. Fewer or more modules may be necessary or desirable in different embodiments.

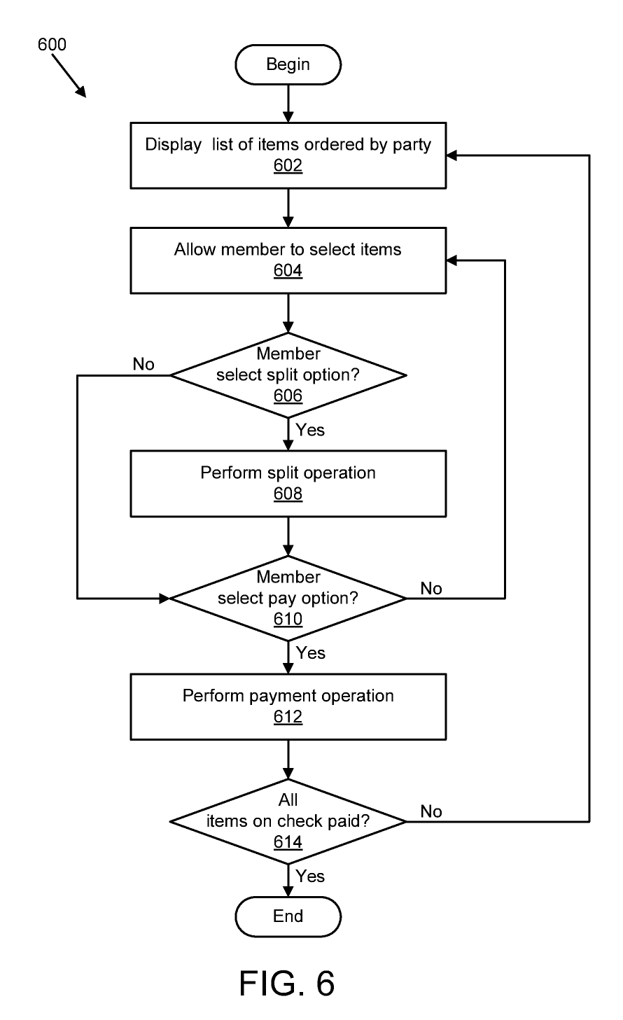

Turning now to FIG. 6, a schematic flow chart diagram illustrating a payment method 600 is shown. According to one embodiment, the method 600 may be performed on a payment apparatus 102 to allow members of a party to select and pay for ordered items. The payment method 600 may be used in a variety of purchasing environments, such as server-customer environments. For simplicity of explanation, however, the payment method 600 will be described in relation to a multi-member party at a restaurant. According to one such embodiment, the payment apparatus 102 is provided to a party consisting of members sitting at a single table in a restaurant.

The payment method 600 begins and the payment apparatus 102 displays 602 a list of items ordered by a party. According to one embodiment, the displaying 602 of the list is performed by the display module 204. The list may be displayed 602 on a display such as the display screen 404 of a payment apparatus 102, or another display. According to one embodiment, the list contains enough details to enable a member of a party to determine which item in the list corresponds to items ordered by the member. According to one embodiment, the list displayed 602 includes check details that describe the ordered items. For example, these check details may include a description of an ordered item and a price of an ordered item. Additionally, or alternatively, these check details may include an amount of the price that has not yet been paid. Additionally or alternatively, the check details may include an amount of the price that has already been paid. According to one embodiment, other options are also displayed with the list. According to the depicted payment method 600, a split option and a payment option are displayed.

The payment apparatus 102 allows 604 a member to select one or more items shown in the list. According to one embodiment, the selection of items is allowed 604 by the selection module 302. A member may select one or more of the items by touching the display screen 404 with a finger or by using another input device, such as a physical keypad, pen device (stylus), or other input devices known in the art. While allowing 604 selection of items, the payment apparatus 102 may also display a split option and a payment option. For example, the split option may displayed in line with a listed item, below the list of items, or at other locations on a display. Similar variations are also possible in displaying the payment option.

If a member selects 606 a split option, the payment apparatus 102 performs 608 a split operation. This split operation, according to one embodiment, may be guided or performed 608 by the selection module 302. The split operation performed 608 may include, according to one embodiment, allowing the entry of a fraction to specify the fraction of the cost of an item a member wishes to pay. According to another embodiment, the split operation may include allowing a member to enter a dollar-cent amount the member wishes to pay for that item. According to one embodiment, the payment apparatus 102 or selection module 302 limits the amount paid to the amount outstanding on the item or less.

If a split option is not selected 606 the payment apparatus 102 may default to not performing 608 a split operation.

If a pay option 602 is not selected, the payment apparatus 102 may continue or once again allow 602 a member to select items from the displayed 602 list of items.

If a member selects 602 a pay option, the payment apparatus 102 performs 612 a payment operation. According to one embodiment, the payment operation is guided or performed 612 by the payment module 206. The payment operation may include steps such as receiving a selection of method of payment, receiving payment details, confirmation of payment details, and/or initiation of a payment transaction. For example, the method of payment may be payment via payment card, personal check, cash, or some other payment method. The payment apparatus 102 may receive payment details through entry into a keypad, swiping of a payment card, or some other method of entering data, such as using other types of input devices. The confirmation of payment details may include allowing a member to confirm previously entered or recorded payment details as correct. According to another embodiment, the payment operation also includes assisting a member in calculating a tip. For example, the payment operation may prompt the member for a dollar-cent value for the tip amount or a percentage for calculating the tip. If the member enters a percentage, the payment apparatus 102 may then calculate the actual tip amount. The initiation of a payment transaction may include communication of payment details to a POS terminal 106 so that the POS terminal 106 can perform a payment transaction.

In response to the performance 612 of a payment operation, the payment apparatus may determine 612 whether the price of all items has been completely paid. If the price of all items has been completely paid, the payment method 600 may end.

If the price of all items on the check has not been paid 614, the payment method 600 returns to displaying 602 a list of items, such as the unpaid items. According to one embodiment, after a payment operation has been performed 612 and the method returns to displaying 602, the payment apparatus is passed to another member of the party. In some embodiments, this method may be repeated multiple times until all items have been paid for.

After a member has paid 612 for at least a portion of the listed items, the list displayed 602 by the payment apparatus 102 may change. According to one embodiment, items completely paid for are no longer displayed 602 in the list. According to another embodiment, paid for items are grayed out or are changed to differentiate from other items. According to another embodiment, the price of the partially-paid-for-item changes to reflect the remaining amount owed. According to another embodiment, paid for items are dropped to the bottom of the displayed list. According to another embodiment, an item that is partially paid for splits into multiple items with the price of each item summing to the total cost of the item.

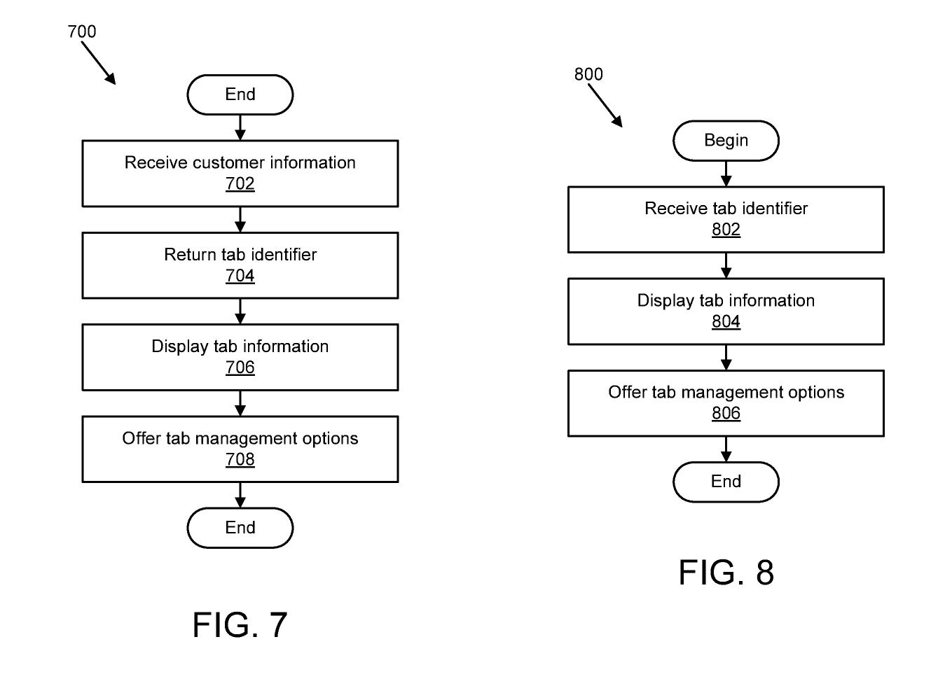

FIG. 7 is a schematic flow chart diagram illustrating a tab creation method 700. According to one embodiment, the tab creation method 700 is performed on the payment apparatus 102, such as by the tab creation module 208. According to another embodiment, the tab creation method 700 is performed on a separate device, such a device connected to a network in communication with the payment apparatus 102. Although the tab creation method 700 may be used in a variety of types of establishments that keep tabs, the method will be described in relation to a bar establishment.

The tab creation method 700 may begin when a customer enters a bar or orders a first item in the bar. According to one embodiment, a server, employee of the bar, payment apparatus 102, or other electronic device requests customer information from the customer. A particular type of customer information may be requested, such as a name, payment card details, a driver's license number, picture, fingerprint, or a number of other types of customer information. The customer may provide the customer information in a variety of manners. For example, the customer information may be provided to an employee or may enter the information into the payment apparatus 102 or other electronic device.

The payment apparatus or other electronic device receives 702 the customer information. According to one embodiment, the customer information is saved to a database, such as the check details database 108, or another device in the payment system 100 of FIG. 1.

In response to receiving 702 the customer information, the payment system 100 returns 704 a tab identifier. According to one embodiment, the tab identifier is returned 704 by any device connected to the network 104. According to one embodiment, a device connected to the network 104 creates a new tab and returns 704 a tab identifier corresponding to the new tab. For example, the tab identifier may be a number, a name, a picture, a random word, a symbol, or a combination of two or more of them. This tab identifier may then be provided to the customer so that the customer can use the tab identifier to access the corresponding tab.

In response to receiving 702 customer information and/or the returning 704 of a tab identifier, the payment apparatus 102 or another electronic device in communication with the network 104 of the payment system 100 may display 706 information about the tab. For example, the tab identifier and/or other customer information may be displayed 706 on the display screen 400 or another display. The tab identifier and/or other customer information displayed 706 may allow a bar employee or the customer to quickly ensure that the displayed tab is the correct tab. The display 706 of the information may also allow a customer or bar employee to confirm that a tab was properly created.

The payment apparatus 102 or other electronic device may also offer 708 tab management options. These options may be offered 708 by displaying text, buttons, or instructions that can be selected or executed by a user of the payment apparatus 102 to perform one or more of the options. These tab management options may include a variety of options or steps to be taken with the tab. For example, the offered 708 tab management options may include an option to add an item to the tab, such as when the customer wishes to order a drink or food item. Other offered 708 tab options may include the deletion of a tab, the changing of customer information on the tab, the application of a coupon or a reward, correction of items on the tab, or any other operation that may be taken with a tab. The display 706 of tab information and the offering 708 of tab information may allow a customer to quickly start a tab and order items from the bar. The tab creation method may then end.

FIG. 8 is a schematic flow chart diagram illustrating a tab access method 800. According to one embodiment, the tab access method 700 is performed on the payment apparatus 102, such as by the tab access module 210.

The tab access method 800 may begin when a customer orders an item in the bar. According to one embodiment, a server, an employee of the bar, a payment apparatus 102, or other electronic device, requests a tab identifier from the customer, such as the tab identifier returned 704 in the tab creation method 700. According to one embodiment, a bar employee, such as a server, enters the tab identifier into the payment apparatus 102. According to another embodiment, a customer enters the tab identifier into the payment apparatus 102.

The payment apparatus 102 receives 802 the tab identifier that has been entered. In response to receiving 802 the tab identifier, the payment apparatus 102 may display 804 information relating to the tab. According to one embodiment, the payment apparatus 102 provides the tab identifier to a device in the payment system 100 of FIG. 1, such as to a device that contains the check details database 108. Tab information may then be returned over the network 104 to the payment apparatus 104, which displays 804 the tab information. According to one embodiment, the tab information displayed 804 by the payment apparatus 102 is a name, a picture, or other type of information. A customer or bar employee may then be able to determine that the proper tab has been accessed. For example, if a picture has been displayed 804 a server can look at the picture to see if the person placing the order is the same as the person in the picture. Other tab information may also be displayed 804, such as the outstanding balance of the tab, or the outstanding items on the tab.

The payment apparatus 102 may also offer 806 tab management options. These options may be offered 806 by displaying text, buttons, or instructions that can be selected or executed by a user of the payment apparatus 102 to perform one or more of the options. These tab management options may include a variety of options or steps to be taken with the tab. For example, the offered 806 tab management options may include an option to add an item to the tab, such as when the customer wishes to order a drink or food item. Other offered 806 tab options may include the deletion of a tab, the changing of customer information on the tab, correction of items on the tab, payment for items on the tab, or any other operation that may be taken with a tab. The display 806 of tab information and the offering 806 of tab information may allow a customer to quickly start a tab and order items from the bar. The tab access method 800 may then end or repeat as needed.

The features, methods, and embodiments discussed within the present disclosure may be of varying utility in different environments or scenarios. Thus, in some embodiments, the payment apparatus 102 may include one or more modes that may be useful in different environments. A user, such as a server, may selectively place the payment apparatus 102 in a mode that best fits the user's current needs. These modes may provide methods, user interfaces, and/or features to facilitate optimal use of the payment apparatus 102 in a specific environment or scenario. Exemplary modes such as a bar mode and a restaurant mode will be described and discussed below.

### Bar Mode Scenario

An exemplary bar mode as set forth herein provides features, methods, and an interface that may best fit the needs of a server or bartender in an exemplary bar environment. In the exemplary bar environment the payment apparatus 102 may be carried throughout a bar establishment by a server or bartender and will be used to place orders and process payment for patrons.

At the beginning of the scenario, a server or bartender places the payment apparatus 102 in a “bar mode.” According to one embodiment, this may be done by swiping security card to bring up and/or select optional modes. The requirement of using a security card may be desirable to allow only authorized users to place the payment apparatus 102 in a specific mode.

After placing the payment apparatus 102 in the bar mode it displays a default bar mode screen. This screen offers a variety of options and features that may be useful in a bar environment. These include tab creation and tab access options offered by the tab creation module 208 and the tab access module 210, respectively. The default bar mode screen may also offer a payment option to instigate payment for an outstanding tab or item or an order option to place an order for a drink or other item directly from the payment apparatus 102. Other options are also available including an option to indicate or switch which bar employee is currently using the payment apparatus 102. This option may also require use of a security card or the entering of a security code.

With the payment apparatus 102 in the bar mode and displaying a default bar mode screen, a server then carries the payment apparatus 102 around the bar establishment to serve patrons. As the server navigates through the establishment a newly arriving customer stops the server and orders a drink. Because the customer has just arrived, the server selects the tab creation option displayed by the payment apparatus 102. The payment apparatus 102 then displays a screen allowing entry of information corresponding to the customer. The screen may allow or request entry of the name of the customer, payment details, and/or other customer information. The server enters the name of the customer and the customer's credit card information. This may be done, for example, by entering the information via a number pad or by swiping a credit/debit card. The server also takes a picture of the customer using the payment apparatus. The tab creation module 208 then creates a new tab corresponding to that customer and prints a receipt displaying a tab identifier. The server provides the receipt to the customer.

At this point, the customer's tab information resides on the payment apparatus 102. The payment apparatus 102 may also send the information to one or more database, such as the check details database 108 of FIG. 1. This would make the information corresponding tab information available to bar employees who are not using the specific payment apparatus 102 into which the information was entered. For example, a server using a separate payment apparatus 102 may place an order against that tab after receiving the customer's tab identifier. Alternatively or additionally, a bartender may be notified of new items ordered against that tab to begin their preparation.

After creating the tab and providing the tab identifier to the customer, the payment apparatus 102 now displays a screen showing information corresponding to the customer's tab with a variety of options to perform on the tab. The server selects an “add” option to add an item to the customer's tab. The payment apparatus 102 displays an order screen allowing the server to select or enter information corresponding to the ordered item. Once again, the payment apparatus 102 may then send this information to a database for storage and/or availability to other bar employees. The server may then select a “finish” option to return to the bar mode default screen.

The server then starts to return to the bar to retrieve the drink ordered by the customer. As the server is returning, another customer stops the server to place an order. The customer provides the tab identifier corresponding to the customer's tab. The server selects the tab access option and enters the tab identifier. The payment apparatus 102 then displays a screen showing information corresponding to the customer's tab, perhaps including a picture of the customer. The server checks the picture to verify that the proper person is ordering against the tab. The server then selects the add option and adds the item ordered by the customer. Once again, the payment apparatus 102 may then send this information to a database for storage.

The server then continues to the bar, retrieves the ordered items and brings them to the corresponding customers. The customer's then provide an incremental tip for the delivered items by providing their tab identifiers and entering a tip amount. After delivering the ordered items, a customer stops the server and wishes to pay for the customer's ordered items and leave. The customer provides the corresponding tab identifier which the server enters and verifies corresponds to the correct tab. If the tab information did not already reside on the payment apparatus 102, the payment apparatus may then communicate with a database to retrieve at least some details corresponding to the tab. If the information was already on the payment apparatus 102, this step may not be necessary.

The server selects a “pay” option. The payment apparatus 102 displays a list of the outstanding items on the tab and a corresponding amount owed by the customer. The payment apparatus 102 may also provide an option to add additional items that were already delivered to the customer but not entered against the tab. Once the tab correctly reflects the items ordered or the items to be paid for by the customer, the server confirms the items with the customer and selects a “continue” option on the screen. Because the customer created the tab using a credit card, the customer then provides a signature using a pen input device on the screen of the payment apparatus 102.

Following input of the signature, the payment apparatus 102 communicates with a POS terminal 106 to perform the payment transaction. According to one embodiment, the payment apparatus 102 communicates the tab identifier to the POS terminal 106 which then retrieves the credit card information from a database and then communicates with a payment server to perform the transaction. According to another embodiment, the payment apparatus 102 communicates all payment details, including credit card number, to the POS terminal 106. According to one embodiment, the payment apparatus 102 communicates the payment details to a credit card gateway, or other device or program that can perform the payment transaction.

When the payment transaction has finished the POS terminal 106 sends a confirmation message to the payment apparatus 102 to notify the server and/or customer that the payment succeeded. The POS terminal 106 also sends the payment details to a database, such as the payment database 110, for storage.

The POS terminal 106, or payment apparatus 102 may then send a message to a database indicating that the customer's tab is paid for and should be closed. The tab may be closed by deleting all or a portion of the information corresponding to the tab, flagging the tab as closed, or some combination of deleting a portion of the tab and flagging it as closed. The method used and the method of communication between the POS terminal 106 and the database may depend on the POS hardware and/or software used.

Throughout the above scenario how data corresponding to customers and tabs is handled may be very important. For example, if data corresponding to multiple customers resides on the payment apparatus 102 at the same time this may speed up the accessing of tabs and/or placing orders. On the other hand, a person with access to the payment apparatus 102 may also be able to more easily access the customer information, such as payment information. Since the server, according to the above scenario, carries the payment apparatus 102 around the establishment, this may not be a great concern as customers may not have time alone with the payment apparatus 102. In other modes, where the payment apparatus 102 may be left alone with a customer, this may be undesirable.

### Restaurant Mode Scenario

An exemplary restaurant mode as set forth herein provides features, methods, and an interface that best fit the needs of restaurant employees and patrons in a restaurant environment. In the exemplary restaurant environment described below the payment apparatus 102 will be carried between tables allowing parties to split up the check for their table.

At the beginning of the scenario, a server or bartender places the payment apparatus 102 in a “restaurant mode.” According to one embodiment, this may be done by swiping security card to bring up and/or select optional modes. The requirement of using a security card may be desirable to allow only authorized users to place the payment apparatus 102 in a specific mode. In another embodiment, a password or passcode is required to change or select a mode.

A party of four individuals enters the restaurant and is seated. A server introduces himself or herself to the party and receives orders for drinks and appetizers. According to one embodiment, the server brings the payment apparatus 102 to the table. In other embodiments, the server does not bring the payment apparatus but takes the orders in a normal way, such as by memory or paper and pencil and communicating the orders to a chef, bartender, or other individual. After taking the orders, the server then enters the order details into an electronic device, such as the POS terminal 106 or the payment apparatus 102. In addition to details corresponding to the ordered items, the server enters the table number at which the party is seated. The electronic device then places the entered details in a check details 108 database.

After allowing the party some time to look over a menu, the server returns and receives orders for menu items. The server enters the orders in a manner similar to that mentioned above, such as through the payment apparatus 102 or through the POS terminal 106. Through the course of the meal, the server may receive additional orders and enter those orders as well.

When the party is ready to pay for the meal they notify the server. The server then prepares the payment apparatus 102 to be presented to the party for payment. This is done by downloading the check details for the items ordered by the party to the payment apparatus 102. According to one embodiment, this is done by entering the table number at which the party is seated. The payment apparatus 102 then communicates with the check details database 108 to retrieve the check details corresponding to table number. According to one embodiment, the payment apparatus 102 communicates with the check details database 108 through the POS terminal using the POS gateway module 510 or through the database gateway module 512. When the check details are all downloaded the server places the payment apparatus 102 in a restaurant payment mode. According to one embodiment the payment apparatus 102 may only be removed from restaurant payment mode by an authorized user, such as by a password or a security card. According to one embodiment, when placed in the payment mode, the payment apparatus 102 removes all check detail in information from the payment apparatus 102 that does not correspond to the party that is about to pay.

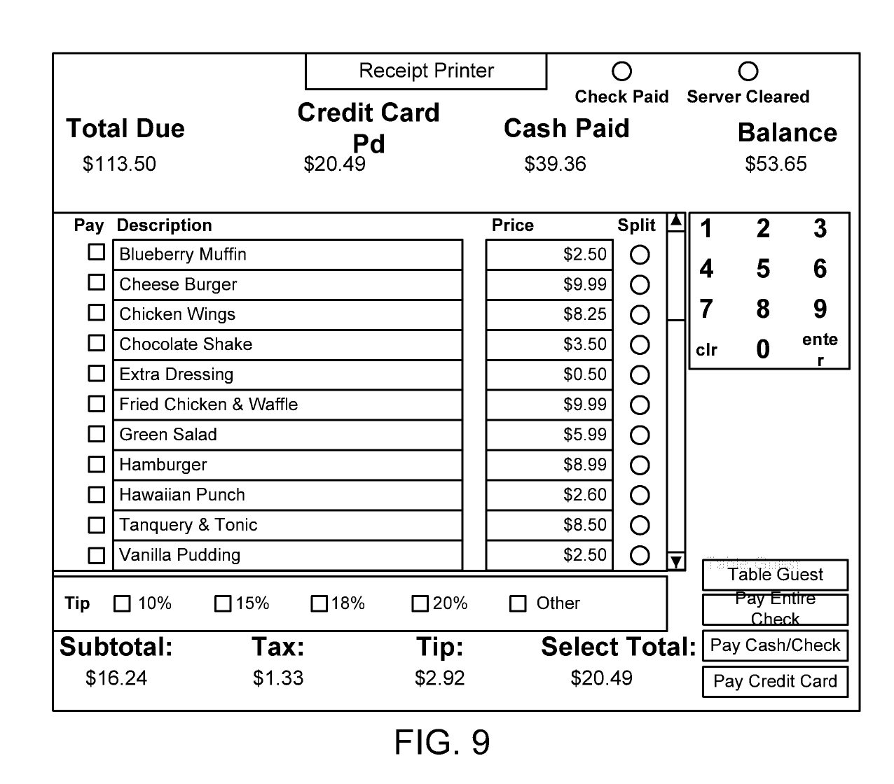

After being placed in the restaurant payment mode 106 the server places the payment apparatus 102 at the party's table. The payment apparatus 102 then provides a user interface for interaction by a user and performs a method similar to the payment method of FIG. 6. FIG. 9 shows an exemplary user interface for interacting with the payment apparatus 102 while in the restaurant payment mode.

According to this exemplary scenario three of the four party members are paying members of the party and the fourth party member is celebrating a birthday. After being placed on the table, the first paying member begins using the payment apparatus 102. The first paying member selects all of the items ordered by the fourth party member who is celebrating a birthday. According to one embodiment, this may be done by selecting the “pay” check box next to the corresponding “item description” by touching them.

After selecting the items, the first paying member selects the “Table Guest” feature by touching that as well. The payment apparatus 102 prompts the user to enter a number corresponding to how the selected items should be split. The first paying member enters “3” to split the items between the three paying members. According to one embodiment, the payment apparatus 102 splits each of the selected items into three separate items of equal value totaling to the total value of the original item and each having the same “description” and the same “price.” One set of these is selected as being paid for.

The first paying member then continues to select the items which the first paying member ordered and is planning on paying the full amount. As the member selects each item the “SubTotal”, “Tax”, “Tip”, and “Select Total” are updated to reflect the items selected. The “SubTotal” corresponds to the sum of the prices of the selected items. The “Tax” corresponds to the amount of tax that will be charged based on the “SubTotal.” The “Tip” corresponds to the amount of tip to be paid and the “Select Total” corresponds to the sum of the “SubTotal” the “Tax” and the “Tip.” The “Tip” amount may default to a 15% amount and may be adjustable by a user. For example, the first paying member could select a 15% tip amount or any other tip amount.

Once all of the items are selected for which the first paying member wishes to pay, the first paying member selects the “Pay Credit Card” option. The payment apparatus 102 then leads the first paying member through a credit card payment transaction, similar to credit card transactions at retail stores. For example, the payment apparatus 102 requests that the member swipe his credit card and provide a signature. Alternatively, the payment apparatus 102 may request a personal identification number PIN or authorization code. The payment apparatus 102 may print a receipt to be signed by the member, or the payment apparatus 102 may allow the member to use a pen input device to provide a signature on the display screen 404. According to one embodiment, the payment apparatus 102 then communicates with the POS terminal 106 to perform the payment transaction with a payment server 112. The payment apparatus 102 then displays a message indicating the success of the transaction. The first paying member then passes the payment apparatus 102 to the second paying member.

When the second paying member receives the payment apparatus 102, items corresponding to a third of the celebrating fourth member are already selected. Items which have been paid for by the first paying member are grayed out and dropped to the bottom of the list. The second member may then proceed to select items for which the member wishes to at least partially pay. The second paying member selects an item which was split between the second paying member and the third paying member. After selecting the item the second paying member select the “Split” option next to the corresponding item. The payment apparatus 102 prompts the user to enter a fraction corresponding to the amount the member wishes to pay. The second paying member enters “2” corresponding to ½ of the item to be split. The item is then split into two equally priced items, each of half the price, with one of the items selected.

The second paying member then continues to select the other items for which he or she wishes to pay. When these are all selected, the second paying member selects the “Pay Cash/Check” option. The payment apparatus 102 prints a receipt corresponding to the amount to be paid by the second paying member. According to one embodiment, the payment apparatus 102 also sends a message to another device, such as the POS terminal 106 that a server is need to handle the cash payment. The second paying member can then provide cash or check to the server along with the receipt and receive any needed change from the server. According to one embodiment, the second paying member can pass the payment apparatus 102 to the third paying member before the server comes to receive the cash payment. According to another embodiment, the second paying member simply leaves the proper amount of cash on the table and requires no change.

The third paying member then selects all the remaining unpaid items and performs a payment transaction in a similar manner to the first paying member. After the third paying member finishes payment, the “Check Paid” indicator is lit and the party can then leave.

When the party has finished paying a server can then take the payment apparatus 102 and remove it from the restaurant payment mode. According to one embodiment, the payment apparatus 102 deletes the check details and/or payment information, such as credit card numbers, from the payment apparatus 102 for security reasons. For example, according to one embodiment, only the last four digits of a credit card number used in a successful transaction are restored. This may be required for security and/or tracking purposes. According to one embodiment, this information is transferred to the check details database 108, the payment database 110, or another database for storage.

The foregoing discussion has focused primarily on functions, features, processes, and methods performed on the custom payment apparatus 102 of FIG. 4 in relation to a bar or restaurant environment. However, as previously mentioned, these same functions, feature, processes and methods may also be performed by other devices and/or in other environments. For example, the above functions, features, processes, and methods may be made available on a computer, on a PDA, or accessible through a website. Additionally, the above functions, features, processes, and methods may be used in paying for food and beverages as described above and/or for services and retail items. For example, the functions features, process, and methods described herein may be used for purchasing clothing, airline tickets, and/or a variety of other items or services. For example, purchase of such items may be done on a website over the internet or may be performed on a payment kiosk or POS terminal at a retail establishment. An exemplary scenario of purchasing airline tickets online will be illustrated below.

### Online Purchasing of Airline Tickets Scenario

An exemplary scenario for purchasing airline tickets online will now be discussed. One of skill in the art will recognize that this scenario is illustrative only and could vary significantly based on the teaching provided herein.

According to the present scenario an individual uses a processing device, such as a computer or a mobile phone, with web browsing capabilities to access a website that enables the online purchasing of airline tickets. The individual is one member of a party of three individuals that going on a business trip to another city and would like to travel together. More particularly, the individuals would like to sit together for the flight. The individual members of the party are each responsible for their own payment so the individual wishes to split payment for the airline tickets.

The individual browses the website and locates three tickets that are seated together to the proper city and adds them to an online shopping cart, such as online shopping carts well known in the art. When all the needed tickets have been adding to the shopping cart, the individual selects an option to check out, or initiate payment. A payment process similar to that discussed in relation to FIGS. 6, 9 and other figures may then be initiated.

During the payment process a list of items (similar to the listin of check details of FIG. 9) in the shopping cart is displayed. The individual selects the items for which the individual wishes to pay. When all the items for which the individual wishes to pay have been selected, the individual selects a “pay” option. The individual is then stepped through the process of entering a name, credit card details, billing address, etc. The individual selects an option to process the payment and the billing to the credit card is processed.

After a message that the billing is successful, the website returns the individual to a listing of the items in the shopping cart. The items which have already been paid for are grayed out. The individual then proceeds to select items to be paid for by a second member of the party. When the proper items have been selected the individual then selects a pay option. According to the present scenario the individual has received the payment details of the second member and proceeds to process the payment in a similar manner that the individual processed the individual's own payment. After processing, a message that the second billing is successful is displayed and the individual is again returned to the listing of the items in the shopping cart.

All of the remaining items are items to be paid for by the third member. The individual selects all of the remaining options. In the current scenario, the individual does not have the payment details for the third member and the third member is not present to enter these details. In other scenarios the third member may be present and may simply be retrieved to enter the third member's payment details. According to this embodiment, however, instead of selecting a “pay” option the individual selects an option to send a bill to the third member. The individual may be prompted for information on how to send the item to the third member. For example, the individual is prompted for an email address for the third member. This information is entered and the bill is sent to the third member.

The remaining unpaid items in the shopping cart will be held open for an amount of time allowing the third party to pay for the items. For example, in the present scenario the website provides a message to the individual that the remaining items must be paid within two hours at which point unpaid items, which include an airline ticket in this scenario, will be available for purchase by others. The individual calls the third member to notify the third member that the bill has been sent to an email address. The third member checks the email and selects a link allowing for payment of the bill. The third member enters payment details corresponding to the items selected by the individual within the time period provided by the website. The party now has ordered and paid for the tickets needed for the business meeting.

The above scenario illustrates how the dividing of an online order of airline tickets between parties can be executed, in one embodiment. As illustrated a single individual is not required to make the purchase of all the tickets and then retrieve a refund from the other members of a party. The website provided features for dividing and paying for the items ordered such that the payment process was more convenient for the parties and still allowed them to sit together on the plane.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to facilitate customer payment, the apparatus comprising:
a computer readable storage medium storing computer readable program code executable by a processor, the computer readable program code comprising:
a display module configured to display check details corresponding to one or more items ordered by a party, the party comprising one or more members, the one or more items displayed on a display screen;
a selection module configured to allow a member of the one or more members of the party to select check details corresponding to one or more of the one or more items, the corresponding one or more items being items for which the member wishes to at least partially pay; and
a payment module configured to allow the member to enter payment details corresponding to a payment method.

2. The apparatus of claim 1, wherein the selection module is further configure to perform a split operation, the split operation comprising selecting a portion of a price less than a full price of the one or more selected items.

3. The apparatus of claim 1, wherein the check details displayed by the display module include one or more of a price of the corresponding one or more items and a description of the corresponding one or more items.

4. The apparatus of claim 1, wherein the payment module is further configure to send payment details to a POS terminal to perform a payment transaction.

5. The apparatus of claim 1, further comprising a security module for maintaining one or more of physical security of the apparatus, security of data residing on the apparatus, and security of data communicated by the apparatus.

6. The apparatus of claim 1, wherein the apparatus further comprises a communication module, the communication module configured to communicate with one or more electronic devices and the communication module comprised in one or more of hardware and the computer readable program code.

7. The apparatus of claim 6, wherein the communication module comprises one or more of a POS gateway module and a database gateway module.

8. The apparatus of claim 1, wherein the payment module is further configured to allow the member to select the payment method.

9. The apparatus of claim 1, wherein the apparatus comprises a mobile phone.

10. The apparatus of claim 1, further comprising the display screen.

11. The apparatus of claim 1, wherein the display screen is a touch screen.

12. The apparatus of claim 1, further comprising one or more of a camera, a printer, and a card slot.

13. A computer program product for customer payment, the computer program product comprising:
a computer readable storage medium having computer readable program code embodied therein, the computer readable program code configured to:
displaying check details corresponding to one or more items ordered by a party, the party comprising one or more members, the one or more items displayed on a display screen;
allowing a member of the one or more members of the party to select check details corresponding to one or more of the one or more items, the corresponding one or more items being items for which the member wishes to at least partially pay; and
allowing the member to enter payment details corresponding to a payment method.

14. The computer program product of claim 13, further comprising allowing the displaying check details, the allowing the member to select check details, and the allowing the member to enter payment details to be performed repeatedly until the check has been completely paid.

15. The computer program product of claim 13, wherein the computer program product is accessible and executable over a network.

16. The computer program product of claim 15, wherein the network comprises one or more of:
a local area network (LAN);
a wide area network (WAN);
a peer to peer network; and
the world wide web.

17. The computer program product of claim 13, wherein the one or more items comprise one or more of:
a beverage item;
a food item;
a retail item;
an airline ticket; and
a service item.

18. The computer program product of claim 13, further comprising displaying a graphical user interface on the display screen, the graphical user interface having a number of features displayed at substantially the same time, the number of features comprising:
a list of the one or more items;
one or more split options;
one or more payment options; and
one or more values indicating the payment status, the one or more values comprising one or more of
a total due;
an unpaid balance;
a subtotal amount for currently selected items from the list of items;
a tax amount for currently selected items from the list of items; and
a tip amount for currently selected items from the list of items.

19. The method for deploying a computer program product, comprising integrating computer readable program code into a computing system, wherein the code in combination with the computing system performs the following:
display check details corresponding to one or more items ordered by a party on a display screen, the one or more items ordered by one or more members of the party;
allow a member of the one or more members of the party to select check details corresponding to one or more of the one or more items, the corresponding one or more items being items for which the member wishes to at least partially pay; and
allow the member to enter payment details corresponding to a payment method.

20. A system to facilitate payment, the system comprising:
a POS terminal;
a check details database, the check details database storing information about items ordered by a party;
a computer readable storage medium having computer readable program code embodied therein, the computer readable program code configured to:
display check details corresponding to one or more items ordered by a party on a display screen, the one or more items ordered by one or more members of the party;
allow a member of the one or more members of the party to select check details corresponding to one or more of the one or more items, the corresponding one or more items being items for which the member wishes to at least partially pay; and
allow the member to enter payment details corresponding to a payment method; and
a network for providing communication between the POS terminal, the check details database, the payment details database, and the apparatus.
